(19) United States
(12) Patent Application Publication
(10) Pub. No.: US 2023/0413042 A1
(43) Pub. Date: Dec. 21, 2023

(54) METHOD FOR SUPPORTING ULTRA-WIDEBAND COMMUNICATION AND APPARATUS IMPLEMENTING THE SAME METHOD

(71) Applicant: SAMSUNG SDS CO., LTD., Seoul (KR)

(72) Inventors: Seung Hoon CHA, Seoul (KR); Dong Ho Kim, Seoul (KR); Jae Hyuk Cho, Seoul (KR)

(73) Assignee: SAMSUNG SDS CO., LTD., Seoul (KR)

(21) Appl. No.: 18/200,989

(22) Filed: May 23, 2023

(30) Foreign Application Priority Data
May 23, 2022 (KR) 10-2022-0062812
Sep. 16, 2022 (KR) 10-2022-0116936

(51) Int. Cl. H04W 12/0471; H04W 64/00; H04W 12/48; H04W 76/30

(52) U.S. Cl. CPC H04W 12/0471; H04W 76/30; H04W 12/48; H04W 64/003

(57) ABSTRACT

Provided are a method for supporting ultra-wideband (UWB) communication and apparatuses (e.g., a terminal and a server) implementing the same method. The method according to some embodiments may include sharing, by a first terminal, a key for UWB ranging with a second terminal through a relay server, the first terminal and the second terminal communicating with the relay server through wireless Internet communication; and performing, by the first terminal, the UWB ranging with the second terminal using the shared key.

### CROSS-REFERENCE TO RELATED APPLICATION(S)

This application claims priority from Korean Patent Application No. 10-2022-0062812 filed on May 23, 2022 and Korean Patent Application No. 10-2022-0116936 filed on Sep. 16, 2022 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method for supporting ultra-wideband (UWB) communication and apparatuses (e.g., a terminal and a server) implementing the same method.

### 2. Description of the Related Art

Recently, the ultra-wideband (UWB) technology has begun to be used for accurate distance measurement and security-enhanced data transmission. In particular, the UWB technology is attracting great attention as technology for precisely measuring the relative position or distance between terminals indoors and outdoors, or enabling access control of buildings or vehicles, payment in stores or public transportation, etc. without contact.

The fine ranging (FiRa) consortium is a group of related companies to define standardized UWB technology and is currently defining technical specifications (i.e., FiRa specifications) regarding communication methods, authentication, and security for convenient use of UWB technology.

Meanwhile, the current FiRa specification specifies that two terminals perform various pre-procedures (e.g., secure channel establishment, ranging (session) data sharing, etc.) through Bluetooth low energy (BLE) communication before performing UWB communication. Therefore, there is a problem in that the UWB communication may not be used when the distance between the two terminals is out of the BLE communication range or when any one terminal is in an environment where the BLE communication is difficult.

### SUMMARY

Aspects of the present disclosure provide a method capable of supporting ultra-wideband (UWB) communication between terminals even in an environment where BLE communication is restricted, and apparatuses implementing the same method.

Aspects of the present disclosure also provide a method capable of quickly initiating UWB ranging between terminals and apparatuses implementing the same method.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for supporting ultra-wideband (UWB) communication. The method may include sharing, by a first terminal, a key for UWB ranging with a second terminal through a relay server, the first terminal and the second terminal communicating with the relay server through wireless Internet communication; and performing, by the first terminal, the UWB ranging with the second terminal using the shared key.

In some embodiments, the sharing of the key may include providing, by an application of the first terminal, address information of the relay server to a fine ranging (FiRa) applet of the first terminal, the FiRa applet being an applet installed in a secure element (SE) of the first terminal; comparing, by the FiRa applet, the provided address information with address information included in a pre-stored credential, the pre-stored credential being used to establish a secure channel; and sharing the key through the relay server in response to a comparison result that the provided address information matches with the address information included in the pre-stored credential.

In some embodiments, the sharing of the key may include establishing a secure channel with the second terminal through the relay server; and sharing the key after the secure channel is established.

In some embodiments, the sharing of the key may include requesting a connection to the relay server before sharing the key, the relay server generating a session between the first terminal and the second terminal as a result of a request for the connection; and requesting release of the connection to the relay server after sharing the key, the relay server deleting the generated session as a result of a request for the release.

In some embodiments, the sharing of the key may include transmitting the key to the relay server using preset address information, and wherein the relay server stores the key in a location indicated by the preset address information, and the second terminal obtains the key from the relay server using the preset address information.

In some embodiments, the performing of the UWB ranging may include setting ranging data including the shared key; and performing the UWB ranging with the second terminal based on the ranging data.

In some embodiments, the performing of the UWB ranging may include sharing ranging data including location information of the first terminal with the second terminal through the relay server.

In some embodiments, the performing of the UWB ranging may include obtaining location information of the second terminal through the relay server; determining a distance between the first terminal and the second terminal using the location information; and initiating the UWB ranging in response to determining that the determined distance is equal to or less than a reference value.

According to another aspect of the present disclosure there is provided a method for supporting ultra-wideband (UWB) communication. The method may include connecting, by a relay server, communication with a first terminal and a second terminal; receiving, by the relay server, a key for UWB ranging from the first terminal; and transmitting, by the relay server, the received key to the second terminal, the first terminal and the second terminal performing the UWB ranging using the key.

In some embodiments, the receiving of the key may include relaying a message for establishing a secure channel, the secure channel being established between the first terminal and the second terminal as a result of the relaying; and receiving the key from the first terminal after the secure channel is established.

In some embodiments, the connecting of the communication may include generating a session between the first terminal and the second terminal, and the method may further include deleting the generated session in response to a connection release request of the first terminal.

In some embodiments, the receiving of the key may include storing the key at a location indicated by address information designated by the first terminal, and the transmitting of the received key may include receiving an inquiry request using the address information from the second terminal; and transmitting the stored key to the second terminal in response to the inquiry request.

In some embodiments, the method may further include receiving, by the relay server, ranging data including location information of the first terminal from the first terminal; and transmitting, by the relay server, the received ranging data to the second terminal.

According to yet another aspect of the present disclosure, there is provided a relay server. The relay server may include one or more processors; a communication interface for performing Internet communication with a first terminal and a second terminal; and a memory for storing one or more instructions, wherein the one or more processors, by executing the one or more instructions, perform operations of: connecting communication with the first terminal and the second terminal; receiving a key for ultra-wideband (UWB) ranging from the first terminal; and transmitting the received key to the second terminal, the first terminal and the second terminal performing the UWB ranging using the key.

### BRIEF DESCRIPTION OF THE DRAWINGS

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims and their equivalents.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The above and other aspects and features of the present disclosure will become more apparent by describing in detail exemplary embodiments thereof with reference to the attached drawings, in which:

FIG. 1 is an exemplary diagram for explaining a communication environment of terminals according to some exemplary embodiments of the present disclosure;

FIG. 2 is an exemplary block diagram illustrating a terminal according to some exemplary embodiments of the present disclosure;

FIG. 3 is an exemplary block diagram illustrating a relay server according to some exemplary embodiments of the present disclosure;

FIG. 4 is an exemplary flowchart schematically illustrating a method for supporting UWB communication according to some exemplary embodiments of the present disclosure;

FIG. 5 is an exemplary flowchart illustrating a registration process according to some exemplary embodiments of the present disclosure;

FIG. 6 is an exemplary flowchart illustrating a key sharing process according to some exemplary embodiments of the present disclosure;

FIGS. 7 to 9 are exemplary detailed flowcharts for additionally explaining a key sharing process according to some exemplary embodiments of the present disclosure;

FIG. 10 is an exemplary flowchart illustrating an ultra-wideband (UWB) ranging process according to some exemplary embodiments of the present disclosure;

FIG. 11 is an exemplary detailed flowchart for additionally explaining the UWB ranging process according to some exemplary embodiments of the present disclosure;

FIG. 12 is an exemplary diagram for explaining an exemplary service scenario to which a method for supporting UWB communication according to some exemplary embodiments of the present disclosure may be applied; and

FIG. 13 illustrates an exemplary computing device capable of implementing apparatuses according to some exemplary embodiments of the present disclosure.

### DETAILED DESCRIPTION OF THE EMBODIMENTS

Hereinafter, various exemplary embodiments of the present disclosure will be described in detail with reference to the accompanying drawings.

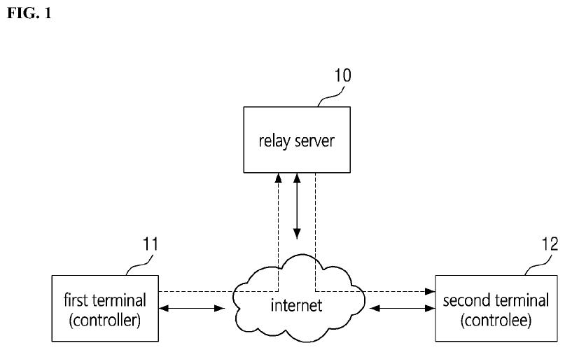

FIG. 1 is an exemplary diagram for explaining a communication environment of terminals 11 and 12 according to some exemplary embodiments of the present disclosure.

As illustrated in FIG. 1, in a communication environment of the terminals 11 and 12 according to the exemplary embodiments, a relay server 10 supporting UWB communication of the terminals 11 and 12 may exist. Hereinafter, each of the terminals 11 and 12 and the relay server 10 will be briefly described.

A first terminal 11 is a terminal that performs UWB communication (e.g., UWB ranging, etc.) with a second terminal 12, and may be a terminal that plays a controller-side role defined in a FiRa specification. An application (e.g., a FiRa-enabled application) in which a controller-side function is implemented may be mounted in the first terminal 11. The first terminal 11 may perform UWB communication with the second terminal 12 with the support of the relay server 10. This will be described in detail with reference to FIG. 4 and subsequent drawings.

The first terminal 11 may include communication modules (interfaces) supporting UWB communication and wireless Internet communication. The module supporting wireless Internet communication may be, for example, a WiFi communication module, a mobile communication module, etc., but the scope of the present disclosure is not limited thereto. The first terminal 11 may perform short-range communication with the second terminal 12 through the UWB communication module, and may also perform communication with the relay server 10 through the wireless Internet communication module.

In addition, the first terminal 11 may further include a communication module supporting other proximity (or short-range) communications other than UWB communication. For example, the first terminal 11 may further include a communication module supporting at least some of communication methods such as NFC, Bluetooth, and BLE.

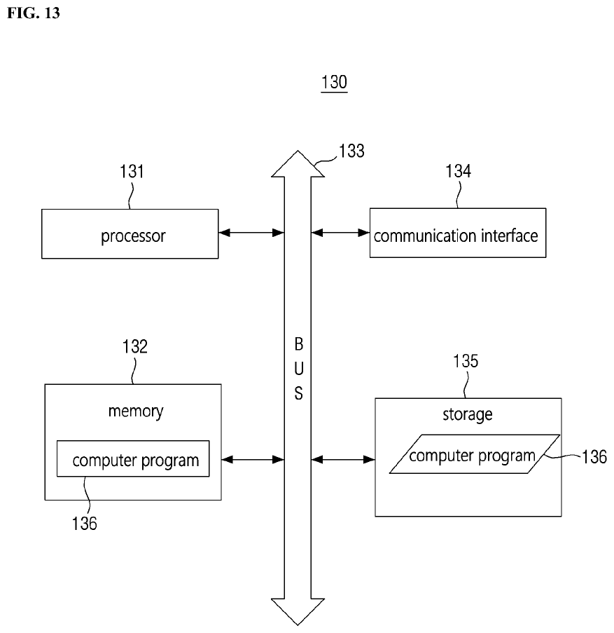

The first terminal 11 may be implemented by a device having a computing function and the above-described communication function, and reference is made to FIG. 13 for an example of such a device.

Next, the second terminal 12 is a terminal that performs UWB communication (e.g., UWB ranging, etc.) with the first terminal 11, and may be a terminal that plays a controlee-side role defined in a FiRa specification. An application (e.g., a FiRa-enabled application) in which a controlee-side function is implemented may be mounted in the second terminal 12. The second terminal 12 may perform UWB communication with the first terminal 11 with the support of the relay server 10. This will be described in detail with reference to FIG. 4 and subsequent drawings.

The second terminal 12 may also include communication modules (interfaces) supporting UWB communication and wireless Internet communication. The module supporting wireless Internet communication may be, for example, a WiFi communication module, a mobile communication module, etc., but the scope of the present disclosure is not limited thereto. The second terminal 12 may perform short-range communication with the first terminal 11 through the UWB communication module, and may also perform communication with the relay server 10 through the wireless Internet communication module.

In addition, the second terminal 12 may further include a communication module supporting other proximity (or short-range) communications other than UWB communication. For example, the second terminal 12 may further include a communication module supporting at least some of communication methods such as NFC, Bluetooth, and BLE.

The second terminal 12 may be implemented by a device having a computing function and the above-described communication function, and reference is made to FIG. 13 for an example of such a device.

Next, the relay server 10 may be a computing device that supports UWB communication between the first terminal 11 and the second terminal 12 in a relay manner. For example, the relay server 10 may support processes (procedures) such as secure channel establishment, key sharing for UWB ranging, etc. between the first terminal 11 and the second terminal 12. Accordingly, the UWB communication may be possible between the first terminal 11 and the second terminal 12 even in an environment where BLE communication is restricted. This will be described in detail with reference to FIG. 4 and subsequent drawings.

For reference, FIG. 1 illustrates that the relay server 10 supports UWB communication between a pair of terminals 11 and 12 as an example, but the scope of the present disclosure is not limited thereto, and the relay server 10 may also support UWB communication between terminals of other pairs. However, in the following description, for convenience of understanding, it is assumed that the relay server 10 supports the first terminal 11 and the second terminal 12.

The relay server 10 may be implemented with one or more computing devices. For example, all functions of the relay server 10 may be implemented with one computing device. As another example, the relay server 10 may be implemented in a plurality of computing devices, and a first function of the relay server 10 may be implemented in a first computing device and a second function thereof may be implemented in a second computing device. Alternatively, a specific function of the relay server 10 may also be implemented in a plurality of computing devices.

The computing device may include any device having a computing function and a communication function, and reference is made to FIG. 13 for an example of such a device. For reference, since the computing device is an aggregate in which a plurality of components (e.g., a process, a memory, etc.) interact, the computing device may also be referred to as a ‘computing system’ in some cases. In addition, the computing system may also refer to an aggregate in which a plurality of computing devices interact for the same purpose.

So far, the communication environment of the terminals 11 and 12 according to some exemplary embodiments of the present disclosure has been described with reference to FIG. 1. Hereinafter, an internal configuration of the terminals 11 and 12 illustrated in FIG. 1 will be further described.

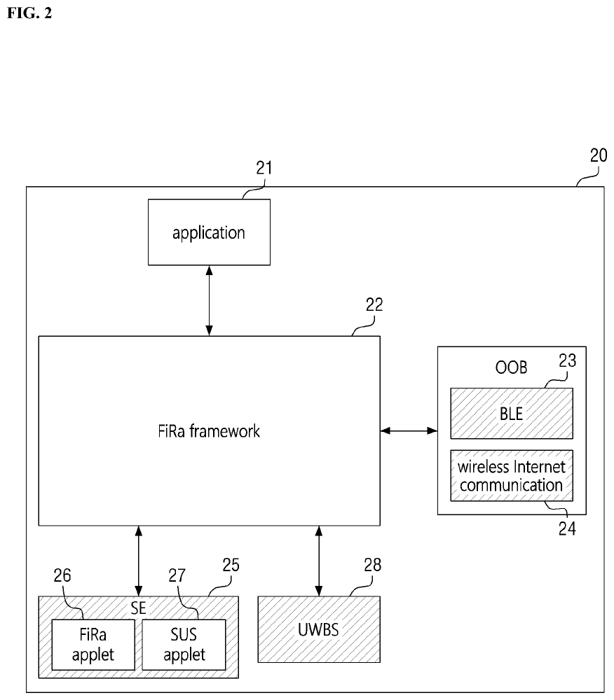

FIG. 2 is an exemplary block diagram illustrating a terminal 20 according to some exemplary embodiments of the present disclosure. The terminal 20 illustrated in FIG. 2 may correspond to the terminals 11 and 12 illustrated in FIG. 1, and a shaded module (e.g., 25) in FIG. 2 means a hardware module. The remaining modules 21 and the like are software modules, and may be implemented with, for example, one or more instructions loaded into a memory (not illustrated) and executed by a processor (not illustrated).

As illustrated in FIG. 2, the terminal 20 according to exemplary embodiments may include one or more applications 21, a FiRa framework 22, a BLE module 23, a wireless Internet communication module 24, a secure element (SE) 24, and an UWB subsystem (UWBS) 27. However, only the components related to the exemplary embodiments of the present disclosure are illustrated in FIG. 2. Therefore, those skilled in the art to which the present disclosure belongs may know that other general-purpose components (e.g., a processor, a memory, an input/output interface, etc.) may be further included in addition to the components illustrated in FIG. 2. In addition, the components of the terminal 20 illustrated in FIG. 2 represent functional elements that are functionally separated, and a plurality of components may also be implemented in a form integrated with each other in an actual physical environment, or a specific functional element may be implemented in a form in which a plurality of sub-functional elements are separated. Hereinafter, each component will be described in detail.

The application 21 may refer to an application (e.g., a controller-side or controlee-side application) in which a service using an UWB communication function (e.g., ranging) is implemented. The application 21 may use various functions specified in the FiRa specification through the FiRa framework 22. For example, the application 21 may use functions supported (provided) by applets 26 and 27 through the FiRa framework 22, and may perform UWB communication or out of band (OOB) communication (e.g., communication other than UWB such as BLE, wireless Internet communication, etc.). In some cases, the application 21 and the FiRa framework 22 may be implemented as one integrated module.

Next, the FiRa framework 22 may refer to a module supporting (providing) various functions specified in the FiRa specification. For a more detailed description of the FiRa framework 22, the reference is made to the FiRa specification.

Next, the SE 25 may mean a secure area provided by the terminal 20 (i.e., a physically separated secure area). Within the SE 25, the applets 26 and 27 may be installed and driven. As illustrated, a FiRa applet 26 and a secure UWB service (SUS) applet 27 may be installed in the SE 25. In addition, in some cases, other applets specified in the FiRa specification (or implementing functions specified in the FiRa specification) may be further installed in the SE 25. For the functions supported (provided) by the FiRa applet 26 and the SUS applet 27 or operations thereof, reference is made to the descriptions of FIG. 4 and subsequent drawings and the FiRa specification.

Next, the UWBS 27 may refer to a module that supports (provides) UWB communication related functions. For a more detailed description of the UWBS 27, the reference is made to the FiRa specification.

Next, the BLE communication module 23 may support (provide) BLE communication related functions.

Next, the wireless Internet communication module 24 may support (provide) wireless Internet communication related functions. As described above, the wireless Internet communication module 24 may be implemented in various ways such as a WiFi communication module, a mobile communication module, and the like, and may be implemented in any way as long as it may support wireless Internet communication.

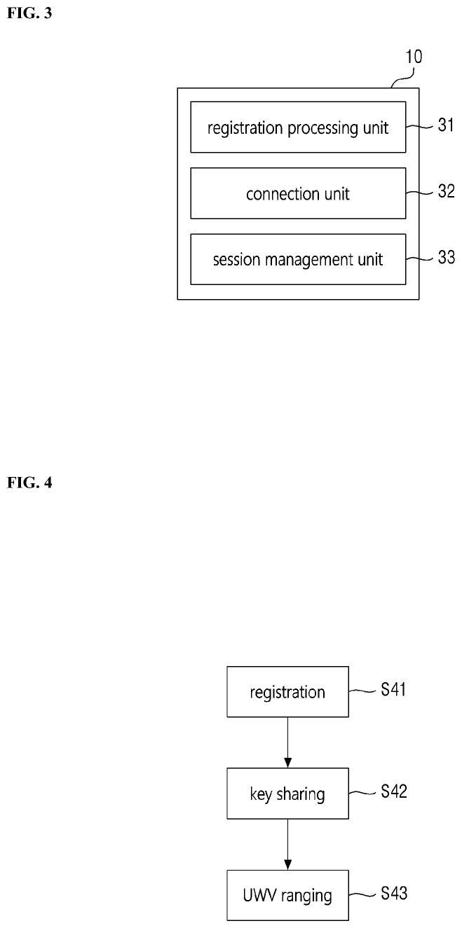

So far, the terminal 20 according to some exemplary embodiments of the present disclosure has been described with reference to FIG. 2. Hereinafter, the configuration and operation of a relay server 10 according to some exemplary embodiments of the present disclosure will be described with reference to FIG. 3.

FIG. 3 is an exemplary block diagram illustrating a relay server 10 according to some exemplary embodiments of the present disclosure.

As illustrated in FIG. 3, the relay server 10 according to exemplary embodiments may include a registration processing unit 31, a connection unit 32, and a session management unit 33. However, only the components related to the exemplary embodiments of the present disclosure are illustrated in FIG. 3. Therefore, those skilled in the art to which the present disclosure belongs may know that other general-purpose components (e.g., a processor, a memory, an input/output interface, etc.) may be further included in addition to the components illustrated in FIG. 3. In addition, the components of the relay server 10 illustrated in FIG. 3 represent functional elements that are functionally separated, and a plurality of components may also be implemented in a form integrated with each other in an actual physical environment, or a specific functional element may be implemented in a form in which a plurality of sub-functional elements are separated. Hereinafter, each component will be described in detail.

The registration processing unit 31 may perform registration processing for the terminals 11 and 12 using the relay server 10. Specifically, the registration processing unit 31 may receive a registration request together with predetermined registration information from the terminals 11 and 12, and may perform registration processing for the terminals 11 and 12 using the received registration information (e.g., store the registration information of the terminals in a registered terminal list).

The predetermined registration information may be, for example, terminal user's account information (e.g., account ID, password, user's name), terminal information (e.g., terminal ID, terminal type, terminal name, etc.), application information (e.g., application ID, application name, etc.), and the like, but the scope of the present disclosure is not limited thereto. For reference, the application ID may be, for example, an object Identifier (OID) specified in the FiRa specification, but the scope of the present disclosure is not limited thereto.

Next, the connection unit 32 may connect or manage Internet communication with each of the terminals 11 and 12. For example, the connection unit 32 may establish, maintain, or terminate a connection for Internet communication with the first terminal 11 and/or the second terminal 12.

Next, the session management unit 33 may manage a session (i.e., a communication session) between the terminals 11 and 12 (e.g., manage a connection state and session information). For example, the session management unit 33 may generate, maintain, or delete a session between terminals 11 and 12 connected to the relay server 10. Here, generating a session may mean that communication between the terminals 11 and 12 is connected through the relay server 10 by generating session information, for example, and the session management unit 33 may allow only communication between the terminals for which the session information exists. The session information may include, for example, IDs of two connected terminals, application IDs of the two terminals, and connection state information, but the scope of the present disclosure is not limited thereto.

Each component of FIG. 3 may mean software or hardware such as a field programmable gate array (FPGA) or an application-specific integrated circuit (ASIC). However, the components are not meant to be limited to software or hardware, and may also be configured to reside in an addressable storage medium and may also be configured to execute one or more processors. Functions provided in the components may be implemented by more subdivided components, and may also be implemented by a single component that performs a specific function by combining a plurality of components. In addition, each component illustrated in FIG. 3 may be implemented as an independent computing device.

So far, the configuration and operation of the relay server 10 according to some exemplary embodiments of the present disclosure have been briefly described with reference to FIG. 3. Hereinafter, a method for supporting UWB communication according to some exemplary embodiments of the present disclosure will be described with reference to FIG. 4 and subsequent drawings.

FIG. 4 is an exemplary flowchart schematically illustrating a method for supporting UWB communication according to some exemplary embodiments of the present disclosure. However, this is only an exemplary embodiment for achieving the object of the present disclosure, and some steps may also be added or deleted as needed.

As illustrated in FIG. 4, a method for supporting UWB communication according to exemplary embodiments may be performed in the order of a registration process S41, a key sharing process S42, and an UWB ranging process S43.

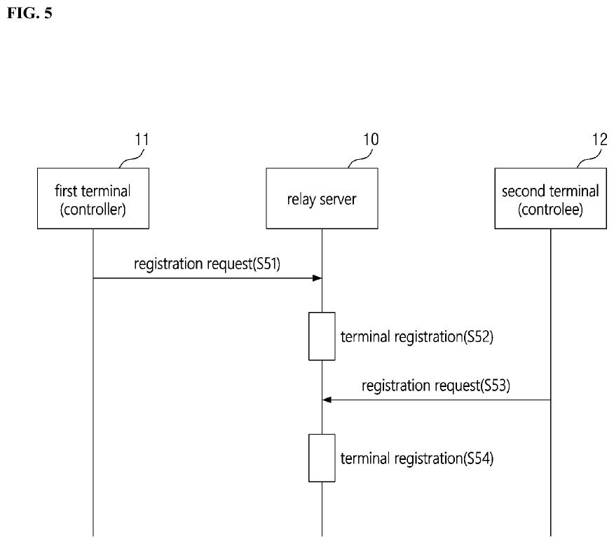

The registration process S41 may refer to a process of registering the terminals 11 and 12 with the relay server 10. This process will be described in detail with reference to FIG. 5.

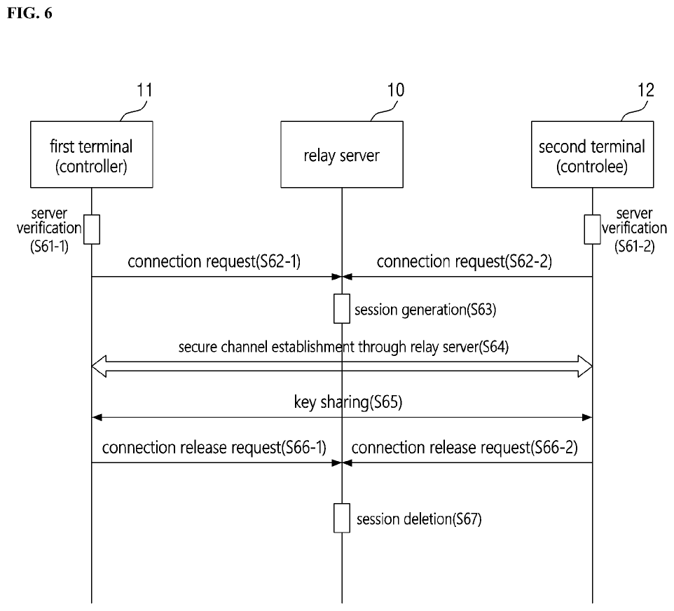

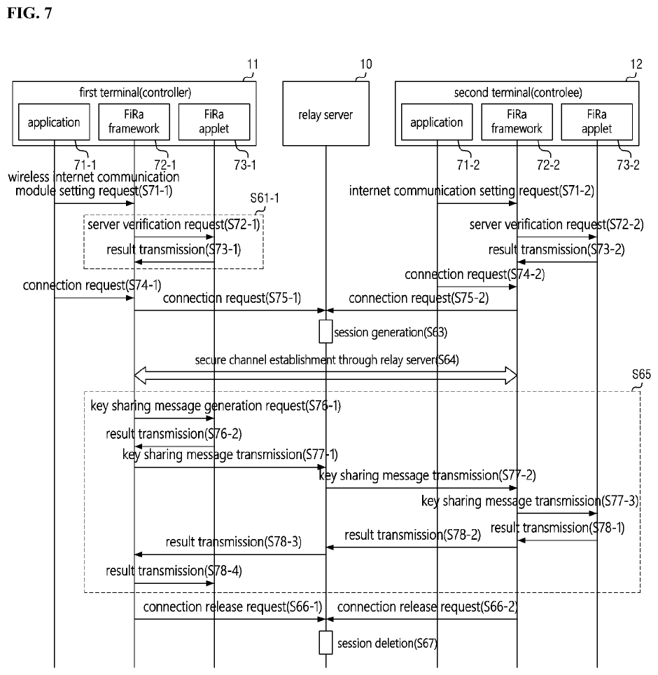

Next, the key sharing process S42 is a pre-procedure for UWB ranging, and may refer to a process of establishing a secure channel through device-to-device authentication and sharing a key for ranging. This process will be described in detail with reference to FIGS. 6 to 9.

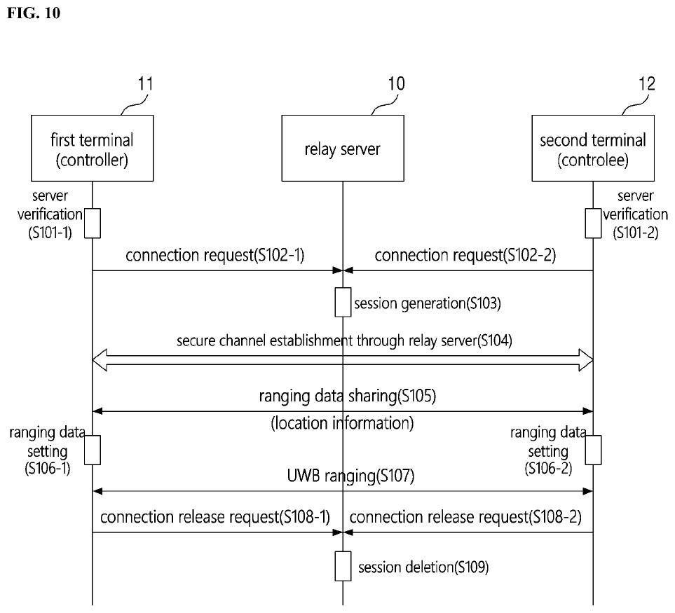

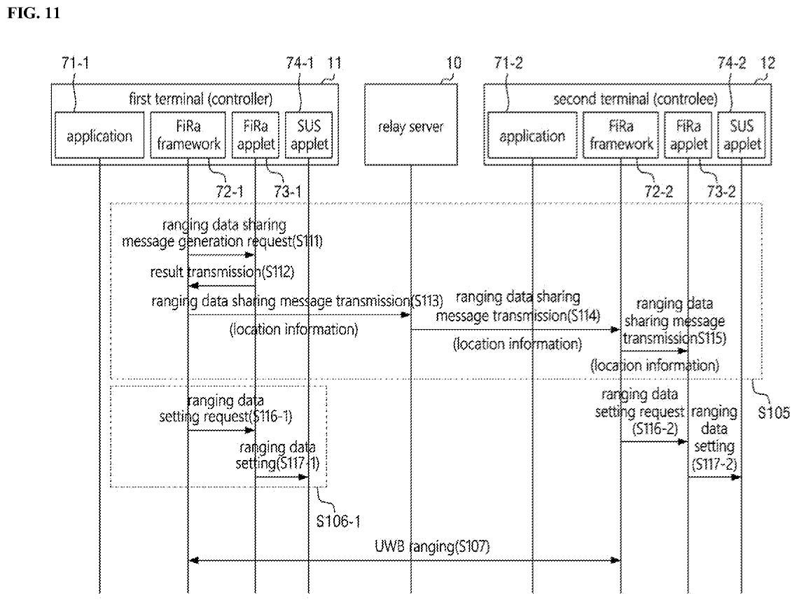

Next, the UWB ranging process S43 may refer to a process of performing UWB ranging between the terminals 11 and 12 using the shared key. This process will be described in detail with reference to FIGS. 10 and 11.

Hereinafter, a registration process according to some exemplary embodiments of the present disclosure will be described with reference to FIG. 5.

FIG. 5 is an exemplary flowchart illustrating a registration process according to some exemplary embodiments of the present disclosure. However, this is only an exemplary embodiment for achieving the object of the present disclosure, and some steps may also be added or deleted as needed.

As illustrated in FIG. 5, in steps S51 and S52, registration processing for the first terminal 11 may be performed. Specifically, the first terminal 11 may transmit a registration request together with predetermined registration information to the relay server 10, and the relay server 10 may perform registration processing for the first terminal 11 based on the received registration information in response to the request. For a registration processing method, the reference is made to the description of the registration processing unit 31 described above.

In steps S53 and S54, registration processing for the second terminal 12 may be performed. For a description thereof, the reference is made to the description of steps S51 and S52 described above.

So far, the registration process according to some exemplary embodiments of the present disclosure has been described with reference to FIG. 5. Hereinafter, a key sharing process according to some exemplary embodiments of the present disclosure will be described with reference to FIG. 6.

FIG. 6 is an exemplary flowchart illustrating a key sharing process according to some exemplary embodiments of the present disclosure. FIG. 6 illustrates that steps S62-1 and S62-2 are performed simultaneously, but this is only for convenience of understanding, and steps S62-1 and S62-2 may be performed at different time points (or orders). Furthermore, other steps (e.g., S66-1, S66-2, etc.) illustrated in the drawings as being performed simultaneously may also be performed at different time points (or orders).

As illustrated in FIG. 6, the key sharing process according to exemplary embodiments may start at step S61-1 or step S61-2 of verifying the relay server 10. For example, each of the first terminal 11 and the second terminal 12 may perform verification of the relay server 10. A detailed process of step S61-1 is illustrated in FIG. 7.

As illustrated in FIG. 7, a server verification step S61-1 may be performed by a FiRa framework S72-1 in response to a request for setting a wireless Internet communication module (interface) by an application 71-1 of the first terminal 11. However, the scope of the present disclosure is not limited thereto, and the server verification step S61-1 may also be performed in response to a connection request (see S74-1) of the application 71-1.

Specifically, in step S71-1, the application 71-1 may provide setting information for the wireless Internet communication module to the FiRa framework 72-1 and request configuration settings for the corresponding communication module. Then, the FiRa framework 72-1 may set the configuration for the corresponding communication module. In this case, the setting information may include, for example, type information indicating wireless Internet communication and address information (e.g., URL information) of the relay server 10. However, the scope of the present disclosure is not limited thereto.

For reference, since the wireless Internet communication module is an OOB communication module, the application 71-1 may request settings for the wireless Internet communication module by calling a ‘FIRAServiceInit( )’ function defined in the FiRa specification and transmitting the exemplified setting information as a parameter of the corresponding function. However, the scope of the present disclosure is not limited thereto.

In step S72-1, the FiRa framework 72-1 may request verification of the relay server 10 to a FiRa applet 73-1. In addition, the FiRa framework 72-1 may provide the address information of the relay server 10 received from the application 71-1 to the FiRa applet 73-1. Then, the relay server 10 is verified by comparing the address information provided by the FiRa applet 73-1 with the address information included in a credential (e.g., a credential received from a provisioning authority).

For reference, credential used for establishing a secure channel may be previously installed in the SE (e.g., see 25 in FIG. 2), and actual address information of the relay server 10 may be included in the credential. Therefore, the FiRa applet 73-1 may verify the relay server 10 to be connected by comparing the provided address information of the relay server 10 with the actual address information included in the credential. In the technical field, a credential may be used interchangeably with the term ‘certificate’.

In step S73-1, the FiRa framework 72-1 may receive a verification result from the FiRa applet 73-1. Depending on the verification result, subsequent steps (e.g., S74-1, etc.) may be suspended (postponed). That is, when it is determined that the address information of the relay server 10 is not valid as the verification result, subsequent steps (e.g., S74-1, etc.) may not be performed.

For the detailed processes (S71-2 to S73-2) of step S61-2, the reference is made to the description of step S61-1.

The description will be provided with reference to FIG. 6 again.

In steps S62-1 and S62-2, the first terminal 11 and the second terminal 12 may request connection to the relay server 10 through the wireless Internet communication module. For example, as illustrated in FIG. 7, the applications 71-1 and 71-2 of the first terminal 11 and the second terminal 12 may request connection to the relay server 10 through the FiRa frameworks 72-1 and 72-2 (S74-1, S75-1, S74-2, and S75-2).

As a more specific example, the first terminal 11 may transmit a terminal ID and a service ID to the relay server 10 and request a connection (see S62-1). Then, the relay server 10 may inquire a terminal (e.g., a terminal capable of connection) having a service ID matching (or identical to) the service ID of the first terminal 11 among the registered terminals, and may transmit a message inducing a connection request to the inquired terminal (i.e., the second terminal 12). Next, the second terminal 12 receiving the induction message may request a connection to the relay server 10 (see S62-2).

For reference, each of the applications 71-1 and 71-2 may request a connection to the relay server 10 by calling the ‘FIRAServiceActivate( )’ function specified in the FiRa specification and transmitting the address information of the relay server 10 and the registration information of the terminals 11 and 12 (e.g., terminal ID, service ID, etc.) as parameters. However, the scope of the present disclosure is not limited thereto.

In step S63, the relay server 10 may establish a connection with each of the first terminal 11 and the second terminal 12, and generate a communication session between the first terminal 11 and the second terminal 12. For example, the relay server 10 may generate a session in response to determining that a first application ID received from the first terminal 11 and a second application ID received from the second terminal 12 match (or are identical). Alternatively, the relay server 10 may transmit a message inducing a connection request to a terminal (i.e., the second terminal 12) having an application ID matching (or identical to) the application ID of the first terminal 11, and may generate a session immediately upon receiving the connection request from the second terminal 12.

For a more detailed description of step S63, the reference is made to the descriptions of the connection unit 32 and the session management unit 33 described above.

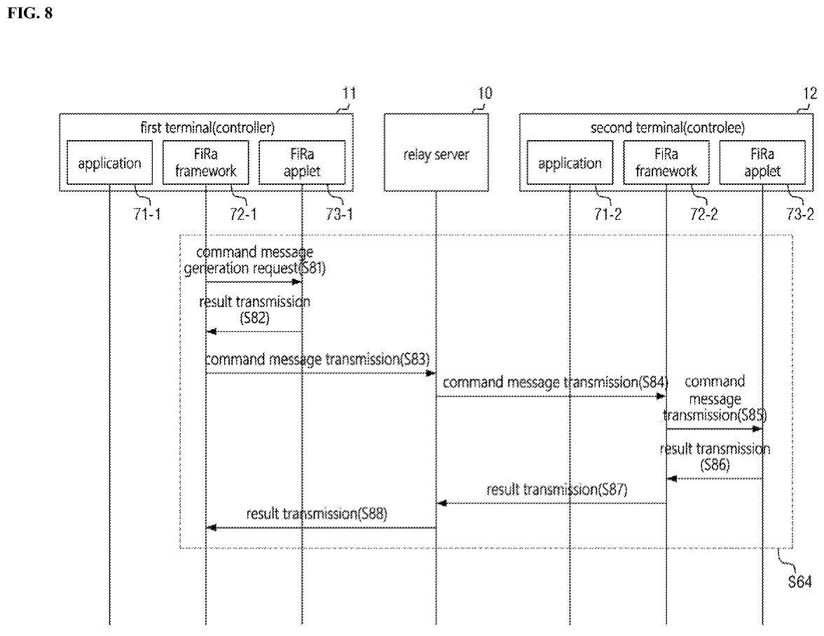

In step S64, a secure channel may be established between the first terminal 11 and the second terminal 12 through the relay server 10. The secure channel may be established according to a method (protocol) specified in the FiRa specification. However, in this step, there is a difference from the FiRa specification in that the relay server 10 relays a command message for establishing the secure channel. For example, as illustrated in FIG. 8, the secure channel may be established between the two terminals 11 and 12 by the relay server 10 relaying a related command message (e.g., GENERAL AUTHENTICATE PART1, GENERAL AUTHENTICATE PART2, etc.) (see S81 to S88).

For reference, the FiRa specification specifies a process of establishing a secure channel through commands (or messages) such as ‘INITIATE TRANSACTION’, ‘SELECT’, ‘GENERAL AUTHENTICATE PART1’, and ‘GENERAL AUTHENTICATE PART2’. Therefore, for a detailed process of step S64, the reference is made to the FiRa specification.

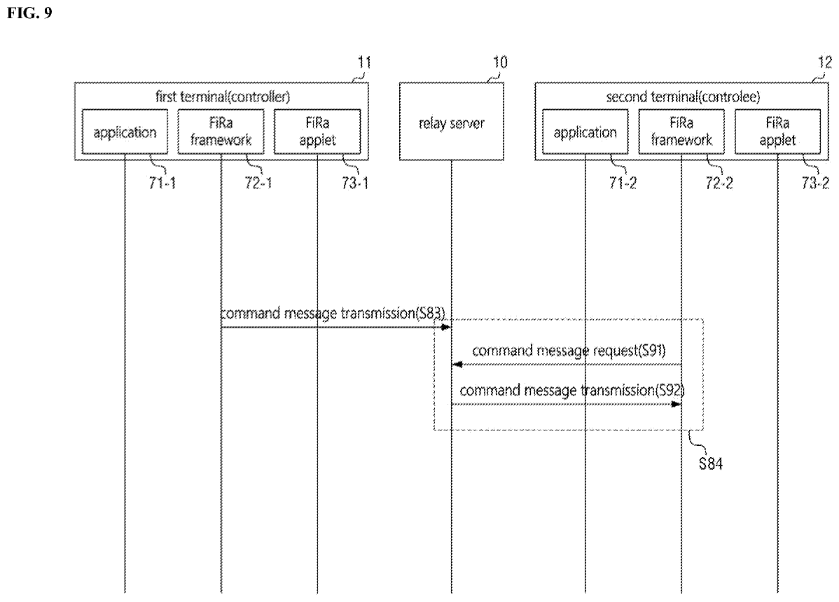

Meanwhile, a method in which the relay server 10 relays a message (or data) may be implemented in various methods. For example, the relay server 10 may operate in a method of transmitting the message of the first terminal 11 to the second terminal 12 as it is (i.e., the relay server 10 operates in a push method). As another example, as illustrated in FIG. 9, the relay server 10 may also operate to transmit the message of the first terminal 11 to the second terminal 12 in response to the request of the second terminal 12 (S91 and S92) (i.e., the relay server 10 operates in a polling method). In other words, when the first terminal 11 transmits a message to predefined address information (e.g., URL), the relay server 10 may store the corresponding message in a location indicated by the address information (and vice versa). In this case, the first terminal 11 may also transmit the terminal ID and application ID together (e.g., when a message is stored by mapping the terminal ID and application ID to the location indicated by the address information). Then, the second terminal 12 may obtain the corresponding message by inquiring the message stored in the relay server 10 using the predefined address information (e.g., URL). In this case, the second terminal 12 may also transmit a terminal ID (e.g., an ID of the first terminal 11 or its own ID) and an application ID to the relay server 10 for message inquiry.

The description will be provided with reference to FIG. 6 again.

In step S65, a key may be shared between the first terminal 11 and the second terminal 12. The key sharing may also be performed through the relay server 10. The corresponding key may be a session key used for UWB ranging or may be a key used to derive the session key. A detailed process of this step is illustrated in FIG. 7.

As illustrated in FIG. 7, in steps S76-1 and S76-2, the FiRa framework 72-1 of the first terminal 11 may request the FiRa applet 73-1 to generate a key sharing message. Then, the FiRa applet 73-1 may generate a key and generate and provide a key sharing message including the corresponding key.

In steps S77-1 to S77-3, the key sharing message may be transmitted from the FiRa framework 72-1 of the first terminal 11 to the FiRa applet 73-2 of the second terminal 12 through the relay server 10. Then, the FiRa applet 73-2 may store the transmitted key in the SE (e.g., see 25 in FIG. 2). As described above, such transmission may also be implemented in a push method or a polling method.

For reference, the message transmission from the FiRa framework (e.g., 72-2) to the FiRa applet (e.g., 73-2) may be implemented through a ‘DISPATCH’ command specified in the FiRa specification, but the scope of the present disclosure is not limited thereto.

In steps S78-1 to S78-4, an execution result of the FiRa applet (i.e., key storage result) may be transmitted to the first terminal 11 through the relay server 10.

The description will be provided with reference to FIG. 6 again.

In steps S66-1, S66-2, and S67, the relay server 10 may delete (terminate) the session between the first terminal 11 and the second terminal 12 in response to a connection release request from the first terminal 11 and the second terminal 12. For example, the relay server 10 may delete the session information including the connection state information between the first terminal 11 and the second terminal 12.

So far, the key sharing process according to some exemplary embodiments of the present disclosure has been described with reference to FIGS. 7 to 9. Hereinafter, an UWB ranging process according to some exemplary embodiments of the present disclosure will be described with reference to FIGS. 10 and 11. However, for clarity of the present disclosure, descriptions of overlapping contents with those of the previous exemplary embodiments will be omitted.

FIG. 10 is an exemplary flowchart illustrating an UWB ranging process, and FIG. 11 is an exemplary detailed flowchart illustrating the UWB ranging process. In FIG. 11, some steps (e.g., server verification step S101-1, session generation step S103, secure channel establishment step S104, etc.) of FIG. 10 overlapping with FIG. 6 are omitted.

As illustrated in FIG. 10, the ranging process according to exemplary embodiments may also start at step S101-1 or step S101-2 of verifying the relay server 10.

In steps S102-1, S102-2, and S103, the relay server 10 may establish a connection with each of the terminals 11 and 12 and generate a session in response to a connection request of the terminals 11 and 12.

In step S104, a secure channel may be established between the first terminal 11 and the second terminal 12 through the relay server 10.

In step S105, ranging data may be shared between the first terminal 11 and the second terminal 12 through the relay server 10. In this case, location information (e.g., GPS information) of each of the terminals 11 and 12 may be shared along with the ranging data. The ranging data may include, for example, a unique identifier (UID) of an application dedicated file (ADF) instance (that is, the UID of an ADF instance associated with the application 71-1), a random value, location information, a session ID, a session key, and the like, but the scope of the present disclosure is not limited thereto. For detailed data items included in the ranging data and a specific method of generating the ranging data, the reference is made to the FiRa specification. In the art, the ranging data may also be named ‘session data’.

For reference, since the session key is shared in advance (see the key sharing process of FIGS. 6 and 7), the ranging data shared in step S105 may not include the session key.

A detailed process of step S105 is illustrated in FIG. 11.

As illustrated in FIG. 11, a ranging data sharing message may be generated by the FiRa applet 73-1 (S111, S112), and may be transmitted to the FiRa applet 73-2 of the second terminal 12 through the relay server 10 (S113 to S115). As illustrated, the ranging data may include location information. However, in some cases, the first terminal 11 may also transmit the location information and the ranging data in different messages.

In some exemplary embodiments, the first terminal 11 may repeatedly share its location information with the second terminal 12 (i.e., continuously update the location information). For example, the first terminal 11 may share its location information with the second terminal 12 through the relay server 10 periodically or whenever the location is changed. In addition, although not illustrated in the drawings, location information of the second terminal 12 may also be shared with the first terminal 11. That is, the first terminal 11 may also obtain the location information of the second terminal 12 through the relay server 10. By doing so, the location information may be shared between users of the terminals 11 and 12 in real time.

The description will be provided with reference to FIG. 10 again.

In steps S106-1 and S106-2, ranging data may be set. For example, as illustrated in FIG. 11, the FiRa frameworks 72-1 and 72-2 of each of the terminals 11 and 12 may request setting of ranging data from the FiRa applets 73-1 and 73-2 (S116-1 and S116-2). Then, the FiRa applets 73-1 and 74-1 may transmit the ranging data to SUS applets 74-1 and 74-2, and the ranging data may be set by the SUS applets 74-1 and 74-2 (S117-1 and S117-2).

In step S107, UWB ranging may be performed between the first terminal and the second terminal.

In some exemplary embodiments, the first terminal 11 may measure a distance between the two terminals 11 and 12 using the location information of the two terminals 11 and 12. In addition, the first terminal 11 may initiate UWB ranging with the second terminal 12 in response to determining that the measured distance is equal to or less than a reference value (e.g., a value set in advance based on an UWB communication range). That is, the first terminal 11 may determine whether the second terminal 12 has entered the UWB communication range, and may immediately start the UWB ranging when it is determined that the second terminal 12 has entered the UWB communication range.

In steps S108-1, S108-2, and S109, the relay server 10 may delete (terminate) the session in response to the connection release request of the terminals 11 and 12.

So far, the UWB ranging process according to some exemplary embodiments of the present disclosure has been described with reference to FIGS. 10 and 11. As described above, UWB communication between the terminals 11 and 12 may be widely supported through the relay server 10 connected to the terminals 11 and 12 through wireless Internet communication. For example, since pre-procedures (e.g., secure channel establishment, ranging key sharing) for UWB ranging between the terminals 11 and 12 may be performed through the relay server 10, the UWB ranging between the terminals 11 and 12 may be smoothly performed even in an environment where Bluetooth low energy (BLE) communication is restricted. Further, as the restrictions of BLE communication are resolved, the spread of services using the UWB communication may be accelerated, and the scope of application of the service may be greatly expanded.

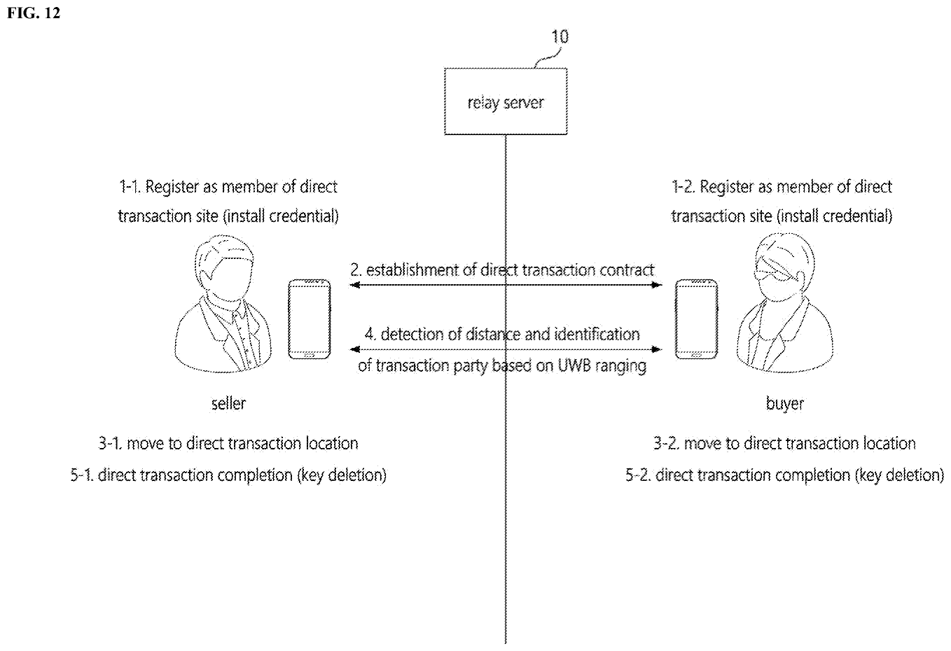

Hereinafter, an exemplary service scenario to which a method for supporting UWB communication according to some exemplary embodiments of the present disclosure may be applied will be briefly described with reference to FIG. 12.

FIG. 12 illustrates an example of providing a direct transaction service between a seller and a buyer based on UWB communication (ranging).

As illustrated in FIG. 12, it is assumed that a seller and a buyer have registered as members of a direct transaction site, and the ADF and credential of the relevant application are installed on a seller's mobile terminal (hereinafter, referred to as ‘seller terminal’) and a buyer's mobile terminal (hereinafter, referred to as ‘buyer terminal’) at the time of membership registration (see 1-1. and 1-2.).

In addition, it is assumed that the seller has registered a product on the direct transaction site, the buyer has requested a purchase reservation for the product through the direct transaction site, and a direct transaction contract is established as the seller approves the requested purchase reservation (see 2.). Then, the seller terminal (i.e., an application of the seller terminal) may share a key for ranging with the buyer terminal through the relay server Such a key sharing process may be implemented to be performed automatically as the seller approves the requested purchase reservation. The implementation method may be any method.

Next, it is assumed that the seller and the buyer have moved to a transaction location for direct transaction (see 3-1. and 3-2.). Then, the seller terminal (i.e., the application of the seller terminal) may share ranging data with the buyer terminal through the relay server and may perform UWB ranging with the buyer terminal. Since the UWB ranging is performed using a key shared only between the seller and the buyer, not only distance measurement but also authentication of the other party may be simultaneously performed through the UWB ranging. In this case, the application of each terminal may display location information of the other party in real time or may notify a message indicating that the other party is nearby.

Next, when the direct transaction is completed, the seller and the buyer may perform a completion process (i.e., direct transaction contract fulfillment completion) through the direct transaction site or an application installed in the terminal. Then, the key shared between the terminals may be deleted (see 5-1. and 5-2.).

So far, the exemplary service scenario to which the method for supporting UWB communication according to some exemplary embodiments of the present disclosure may be applied has been described with reference to FIG. 12.

According to some exemplary embodiments of the present disclosure, ultra-wideband (UWB) communication between terminals may be widely supported through a relay server connected to the terminals through wireless Internet communication. For example, since pre-procedures for UWB ranging between the terminals (e.g., secure channel establishment, ranging key sharing) may be performed through the relay server, the UWB ranging between the terminals may be smoothly performed even in an environment where Bluetooth low energy (BLE) communication is restricted.

Further, as the restrictions of BLE communication are resolved, the spread of services using the UWB communication may be accelerated, and the scope of application of the service may be greatly expanded.

Further, by sharing location information of terminals through a relay server, users of the terminals may easily identify each other's locations.

Further, by sharing ranging data in advance through a relay server, UWB ranging may be started quickly (immediately) when two terminals come within an UWB communication range.

Effects according to the technical idea of the present disclosure are not limited to the effects mentioned above, and other effects that are not mentioned may be obviously understood by those skilled in the art from the following description.

Hereinafter, an exemplary computing device 130 capable of implementing the devices (e.g., the terminal 11, the terminal 12, and the relay server 10) according to some exemplary embodiments of the present disclosure will be briefly described with reference to FIG. 13.

FIG. 13 illustrates a hardware configuration diagram of a computing device 130.

As illustrated in FIG. 13, a computing device 130 may include one or more processors 131, a bus 133, a communication interface 132, a memory 134 for loading a computer program 136 executed by the processor 131, and a storage 135 for storing the computer program 136.

The processor 131 may control an overall operation of each component of the computing device 130. The processor 131 may be configured to include at least one of a central processing unit (CPU), a micro processor unit (MPU), a micro controller unit (MCU), a graphic processing unit (GPU), or any type of processor well known in the art. In addition, the processor 131 may perform a calculation on at least one applet, application and/or program for executing the methods/operations according to various exemplary embodiments of the present disclosure. The computing device 130 may include one or more processors 131.

Next, the memory 134 stores various data, commands, and/or information. The memory 134 may load one or more computer programs 136 from the storage 135 to execute the methods/operations according to various exemplary embodiments of the present disclosure. An example of the memory 134 may be a RAM, but is not limited thereto.

Next, the bus 133 may provide a communications function between the components of the computing device 130. The bus 133 may be implemented as various types of buses, such as an address bus, a data bus, and a control bus.

Next, the communication interface 132 may support wired/wireless communications of the computing device 130. For example, the communication interface 132 may support various types of proximity communication (e.g., UWB, BLE Bluetooth, NFC, etc.), and may further support various communication methods (e.g., wired/wireless Internet communication). The communication interface 132 may include a communication module well known in the art of the present disclosure.

Next, the storage 135 may non-temporarily store one or more computer programs 136. The storage 135 may include a non-volatile memory such as a flash memory, a hard disk, a removable disk, or any type of computer-readable recording medium well known in the art to which the present disclosure belongs.

The computer program 136 may include one or more instructions in which the methods/operations according to various exemplary embodiments of the present disclosure are implemented. When the computer program 136 is loaded into the memory 134, the processor 131 may perform the methods/operations according to various exemplary embodiments of the present disclosure by executing the loaded instructions.

For example, the computer program 136 may include instructions for performing an operation of sharing a key for UWB ranging with a second terminal 12 through a relay server 10 and an operation of performing the UWB ranging with the second terminal 12 using the shared key. In this case, the first terminal 11 according to some exemplary embodiments of the present disclosure may be implemented through the computing device 130.

As another example, the computer program 136 may include instructions for performing an operation of sharing a key for UWB ranging with a first terminal 11 through a relay server 10 and an operation of performing the UWB ranging with the first terminal 11 using the shared key. In this case, the second terminal 12 according to some exemplary embodiments of the present disclosure may be implemented through the computing device 130.

As still another example, the computer program 136 may include instructions for performing an operation of connecting communication with the first terminal 11 and the second terminal 12, an operation of receiving a key for UWB ranging from the first terminal 11, and an operation of transmitting the received key to the second terminal 12. In this case, the relay server 10 according to some exemplary embodiments of the present disclosure may be implemented through the computing device 130.

So far, the exemplary computing device 130 capable of implementing the devices (e.g., the terminal 11, the terminal 12, and the relay server 10) according to some exemplary embodiments of the present disclosure has been described with reference to FIG. 13.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for supporting ultra-wideband (UWB) communication, the method comprising:
sharing, by a first terminal, a key for UWB ranging with a second terminal through a relay server, the first terminal and the second terminal communicating with the relay server through wireless Internet communication; and
performing, by the first terminal, the UWB ranging with the second terminal using the shared key.

2. The method of claim 1, wherein the sharing of the key comprises:
providing, by an application of the first terminal, address information of the relay server to a fine ranging (FiRa) applet of the first terminal, the FiRa applet being an applet installed in a secure element (SE) of the first terminal;
comparing, by the FiRa applet, the provided address information with address information included in a pre-stored credential, the pre-stored credential being used to establish a secure channel; and
sharing the key through the relay server in response to a comparison result that the provided address information matches with the address information included in the pre-stored credential.

3. The method of claim 1, wherein the sharing of the key comprises:
establishing a secure channel with the second terminal through the relay server; and
sharing the key after the secure channel is established.

4. The method of claim 1, wherein the sharing of the key comprises:
requesting a connection to the relay server before sharing the key, the relay server generating a session between the first terminal and the second terminal as a result of a request for the connection; and
requesting release of the connection to the relay server after sharing the key, the relay server deleting the generated session as a result of a request for the release.

5. The method of claim 4, wherein the requesting of the connection comprises transmitting an ID of a first application installed in the first terminal and requesting the connection, and
wherein the first application is an application associated with the UWB ranging, and
the relay server generates the session in response to determining that the ID of the first application matches an ID of a second application installed in the second terminal.

6. The method of claim 1, wherein the sharing of the key comprises transmitting the key to the relay server using preset address information, and
wherein the relay server stores the key in a location indicated by the preset address information, and
the second terminal obtains the key from the relay server using the preset address information.

7. The method of claim 1, wherein the performing of the UWB ranging comprises:
setting ranging data including the shared key; and
performing the UWB ranging with the second terminal based on the ranging data.

8. The method of claim 1, wherein the performing of the UWB ranging comprises sharing ranging data including location information of the first terminal with the second terminal through the relay server.

9. The method of claim 1, wherein the performing of the UWB ranging comprises:
obtaining location information of the second terminal through the relay server;
determining a distance between the first terminal and the second terminal using the location information; and
initiating the UWB ranging in response to determining that the determined distance is equal to or less than a reference value.

10. A method for supporting ultra-wideband (UWB) communication, the method comprising:
connecting, by a relay server, communication with a first terminal and a second terminal;
receiving, by the relay server, a key for UWB ranging from the first terminal; and
transmitting, by the relay server, the received key to the second terminal, the first terminal and the second terminal performing the UWB ranging using the key.

11. The method of claim 10, wherein the receiving of the key comprises:
relaying a message for establishing a secure channel, the secure channel being established between the first terminal and the second terminal as a result of the relaying; and
receiving the key from the first terminal after the secure channel is established.

12. The method of claim 10, wherein the connecting of the communication comprises generating a session between the first terminal and the second terminal, and
wherein the method further comprises deleting the generated session in response to a connection release request of the first terminal.

13. The method of claim 12, wherein the generating of the session comprises:
receiving an ID of a first application installed in the first terminal from the first terminal;
receiving an ID of a second application installed in the second terminal from the second terminal; and
generating the session in response to determining that the ID of the first application matches the ID of the second application installed in the second terminal.

14. The method of claim 10, wherein the receiving of the key comprises storing the key at a location indicated by address information designated by the first terminal, and
wherein the transmitting of the received key comprises:
receiving an inquiry request using the address information from the second terminal; and
transmitting the stored key to the second terminal in response to the inquiry request.

15. The method of claim 10, further comprising:
receiving, by the relay server, ranging data including location information of the first terminal from the first terminal; and
transmitting, by the relay server, the received ranging data to the second terminal.

16. A relay server comprising:
one or more processors;
a communication interface for performing Internet communication with a first terminal and a second terminal; and
a memory for storing one or more instructions,
wherein the one or more processors, by executing the one or more instructions, perform operations of:
connecting communication with the first terminal and the second terminal;
receiving a key for ultra-wideband (UWB) ranging from the first terminal; and
transmitting the received key to the second terminal, the first terminal and the second terminal performing the UWB ranging using the key.
